(19) United States
(12) Patent Application Publication
(10) Pub. No.: US 2014/0152628 A1
(43) Pub. Date: Jun. 5, 2014

(54) COMPUTER INPUT DEVICE FOR HAND-HELD DEVICES

(71) Applicant: Cherif Atia Algreatly, Newark, CA (US)

(72) Inventor: Cherif Atia Algreatly, Newark, CA (US)

(73) Assignee: Cherif Atia Algreatly, Newark, CA (US)

(21) Appl. No.: 14/146,008

(22) Filed: Jan. 2, 2014

Related U.S. Application Data
(63) Continuation-in-part of application No. 12/587,339, filed on Oct. 6, 2009.

(51) Int. Cl. G06F 3/01

(52) U.S. Cl. CPC G06F 3/014
USPC 345/179

(57) ABSTRACT

The present invention discloses a minuscule wireless computer input device to be positioned on the fingertip to provide various functions. For example, the user can effortlessly move or rotate objects in 3D on a computer screen when his/her fingertip touches the screen. The fingertip movement on a surface functions as a computer mouse to manipulate the movement of the computer cursor on a screen. The device can be attached to a stylist, pencil, or similar tools, and also be easily detached or attached at any moment. It is perfectly adaptable for use with HMDs, such as GOOGLE GLASS, while exploring the landscape, driving a car, or lying supine with the need to interact with a computer application.

### CROSS-REFERENCE TO RELATED APPLICATION

This application is a continuation-in-part of a U.S. patent application Ser. No. 12/587,339, filed Oct. 6, 2009, titled “Touch Sensing Technology”.

### BACKGROUND

The touchscreen, touchpad, computer mouse, and the keyboard are the most common forms of computer input devices. Each of these computer input devices has its own uses and deployment, and accordingly, the computer user almost needs all such different input devices in his/her daily use for the computer, tablet, and mobile phone. Until now there has been no universal input device that can function as a touchscreen, touchpad, computer mouse, and keyboard at the same time. In fact, if such a universal input device were to be invented it would dramatically change the way we interact with the computer, and accordingly, increase our productivity.

### SUMMARY

The present invention discloses a computer input device that can function as a touchscreen, touchpad, computer mouse, and keyboard at the same time. The device has a small size so that it can be attached to a fingertip to be operated by a finger on the hand. Touching the computer display with the finger, while wearing the device, causes the computer screen to a function like a touchscreen. Also, touching any surface with the device converts this surface to a functioning a touchpad. Moving the finger with the device on a surface manipulates the computer cursor to move on the computer display in two dimensions. Tilting or rotating the finger with the device enables the objects to be moved or rotated in three-dimensions on the computer display. Using one finger with the device enables the user to type while s/he is kept away from a computer, without a keyboard accessory.

The device can provide an immediate input to the mobile phone or tablet with a single finger while carrying the mobile phone or tablet with this hand. In this case, there is no need to move the finger at all or even to touch the touchscreen of the mobile phone or tablet to provide the input. For the head mounted computer displays in the form of eye glasses, like GOOGLE GLAS, the device is perfect for a simple interaction with computer applications presented on the eye glass while the user is walking in the street, driving a car, or lying supine. The device can function in different forms and manners. For example, it can be attached to a computer keyboard, touchscreen, computer mouse or a desk surface instead of worn exclusively it on a fingertip. It can also be attached to a stylus or a pen to perform the same function, and give the user a variety of choices to suit his/her needs or preferences.

### BRIEF DESCRIPTION OF THE DRAWINGS

FIG. 1 illustrates the way of attaching the device of the present invention to a finger according to one embodiment.

FIG. 2 illustrates tilting the device backward on a surface to provide an immediate input to the computer system, representing a movement along the positive x-axis.

FIG. 3 illustrates tilting the device forward on the surface to provide an immediate input to the computer system, representing a movement along the negative x-axis.

FIG. 4 illustrates using the device of the present invention with a finger to interact with a 3D virtual environment presented on a tablet screen.

FIG. 5 illustrates holding a tablet with a hand while using the device with a finger to target an object located in a 3D environment presented on the tablet screen.

FIG. 6 illustrates interacting with an application on a computer display with a hand while utilizing the device of the present invention with the other hand.

FIG. 7 illustrates interacting with an application on a mobile phone display with a hand while utilizing the device of the present invention with the other hand.

FIG. 8 illustrates holding a mobile phone with a hand while using the device of the present invention with the same hand to provide an immediate input to the mobile phone.

FIG. 9 illustrates holding a mobile phone with a hand while using the device of the present invention on the back side of the mobile phone.

FIG. 10 illustrates using the device of the present invention while talking on the phone to provide shortcuts for an application presented on the mobile phone screen.

FIG. 11 illustrates using the device of the present invention with a finger of a hand while also using a stylus with the same hand.

FIG. 12 illustrates using the device of the present invention two fingers of a hand while using a pencil with the same hand.

FIG. 13 illustrates using the device of the present invention to interact with the 2D/3D computer applications presented on a head mounted computer display.

FIGS. 14 and 15 illustrate simultaneously using two devices of the present invention, with two fingers of the same hand, to provide an input to the computer system representing shortcuts.

FIG. 16 illustrates simultaneously using two devices of the present invention, each attached to a hand, to provide an input to the computer system representing shortcuts.

FIG. 17 illustrates attaching the device of the present invention to a surface of a computer, touchscreen, computer mouse, or the like.

FIG. 18 illustrates replacing the first part of the device with a ball that can be pushed or tilted by a user's hand.

FIG. 19 illustrates using the ball of the present invention to provide six degrees of freedom to the computer system.

FIGS. 20 and 21 illustrate horizontal and vertical sections of the device of the present invention according to one embodiment.

FIGS. 22 to 24 illustrate another form of the device of the present invention according to one embodiment.

### DETAILED DESCRIPTION

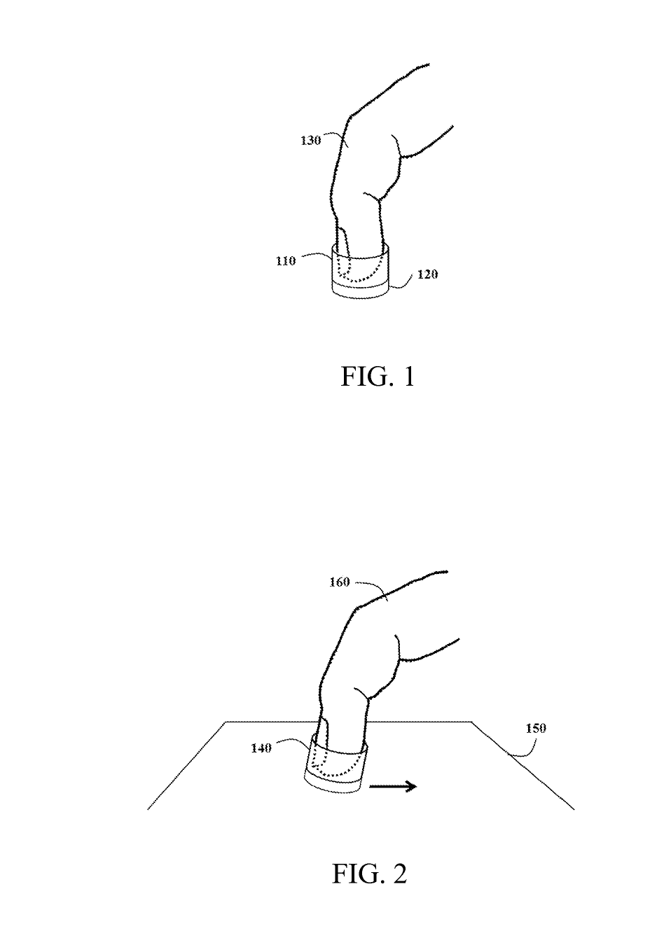

In one embodiment, the present invention discloses a compute input device capable of detecting the 3D direction of a force exerted on the device surface. The device can be attached to a hand finger to detect the 3D direction of the finger when the device touches a surface. For example, FIG. 1 illustrates the way of attaching the device to a fingertip. As shown in the figure, the device is comprised of a first part 110 and a second part 120. The first part is in the form of a hollow cylinder that enables the user to insert his/her finger 130 inside this part to move the device with the finger movement. The second part is in the form of a solid cylinder containing the sensors of the present invention as will be described subsequently.

Moving the device in a path on a surface exerts a force on the second part of the device in the opposite direction of the path due to the friction between the second part and the service. The device can detect the direction of the force which represents the opposite direction of the path. This is utilized in manipulating the computer cursor or the virtual object to move in two-dimensions on the computer display. For example, to move the computer cursor from left to right on the computer display, the finger is moved with the device from left to right on the surface. To move the computer cursor in a circular path on the computer display, the finger is moved with the device in a circular path on the surface.

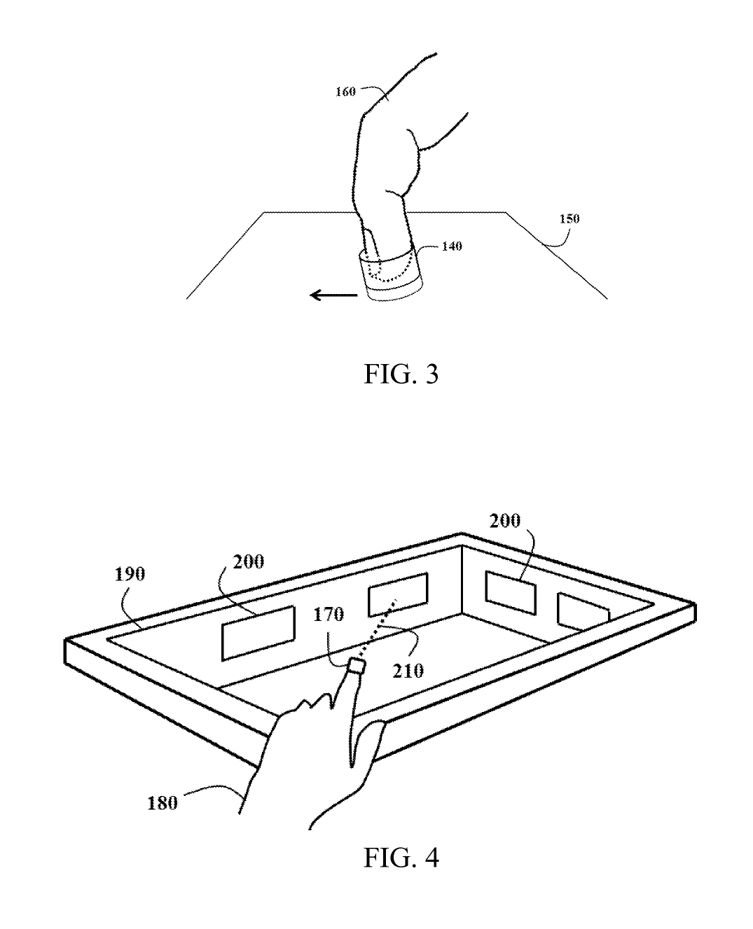

The aforementioned is in case the user prefers to move his/her finger with the device on a surface. If the user prefers not to move his/her finger, the movement is replaced with a tilting of the device without changing the position of the device on the surface. For example, FIG. 2 illustrates tilting the device 140 backward on a surface 150 with the finger 160 to provide an immediate input to the computer system, representing a movement along the positive x-axis. FIG. 3 illustrates tilting the device 140 forward on the surface 150 with the finger 160 to provide an immediate input to the computer system, representing a movement along the negative x-axis. Tilting the device from left to right provides an immediate input to the computer system representing a movement along the positive y-axis. Tilting the device from right to left provides an immediate input to the computer system, representing a movement along the negative y-axis.

Generally, the device of the present invention detects the 3D direction of the force exerted on the device surface. The 3D direction is represented by a first angle located between the xy-plane and a line representing the force, and a second angle located between the projection of the line on the xy-plane and the x-axis. In other words, the 3D direction of the force can be represented by the two angles (θ, φ) of the spherical coordinate system. In fact, titling the finger with the device, while touching a surface, exerts a 3D force on the second part of the device. The sensors of the second part of the device detect the 3D direction of this 3D force which determines the 3D direction of the tilting.

This unique capability of the device of the present invention can lead to tons of innovative computer applications. For example, FIG. 4 illustrates using the device 170 of the present invention with a finger of a hand 180 to interact with a 3D virtual environment presented on a tablet screen 190. As shown in the figure, a plurality of virtual objects 200 is located in 3D on the tablet display. If the device touches the boundaries of the tablet display while it is tilted in a 3D direction towards a virtual object, then this virtual object is selected. The dotted line 210 in the figure shows the 3D direction of tilting the device, which meets with the selected object.

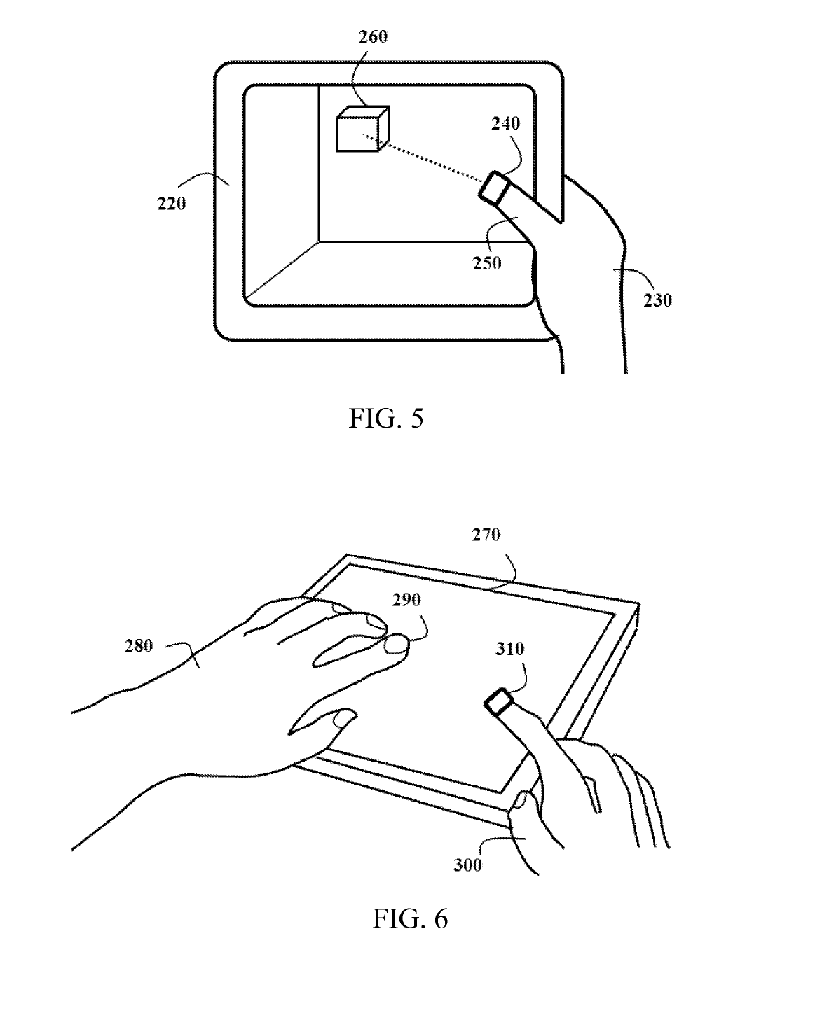

FIG. 5 illustrates holding a tablet 220 with a hand 230 while using the device 240 with a finger 250 of the same hand to target a virtual object 260 located in the 3D environment presented on the tablet screen. As shown in the figure, the hand simultaneously holds the tablet and interacts with the 3D application on the tablet screen. This is hard to be achieved without using the present invention which enables selecting an object on the touchscreen without the need to touch the exact position of the object on the screen. To move the object from one position to another in three-dimensions, the device is tilted towards the new position after selecting the object.

To figure out which object on the tablet screen faces the 3D direction of the device, the computer system of the tablet utilizes two pieces of information. The first piece of information is the location of the point of touch between the device and the tablet screen. The second piece of information is the 3D direction of the device, which can be represented by a ray described by the two angles “θ” and “φ” of the spherical coordinate system. Using the x and y coordinates of the point of touch with the equation of the ray determines the object in the 3D environment on the tablet screen that intersects with the 3D direction of the device tilting.

In FIG. 5, if the computer application presented on the tablet screen is a 2D application, in this case, the angle “0” of the device tilting is ignored. This leads to only utilizing the direction of the ray parallel to the plane of the tablet screen. Generally, the 2D direction of the device is utilized in manipulating the virtual object to move in two-dimensions on the tablet screen. For the computer, the 2D direction of the device can be utilized in manipulating the cursor to move in two dimensions on the computer display. In this case, the direction of tilting the device, in 2D applications, determines the direction of moving the cursor on the computer display. To determine the distance of the cursor movement in this direction, the time period of tilting the device is considered. As long as the device is tilted the cursor keeps moving in the direction of tilting. The speed of moving the cursor can be represented by the value of the force exerted on the device. Once the tilting is released the cursor stops the movement.

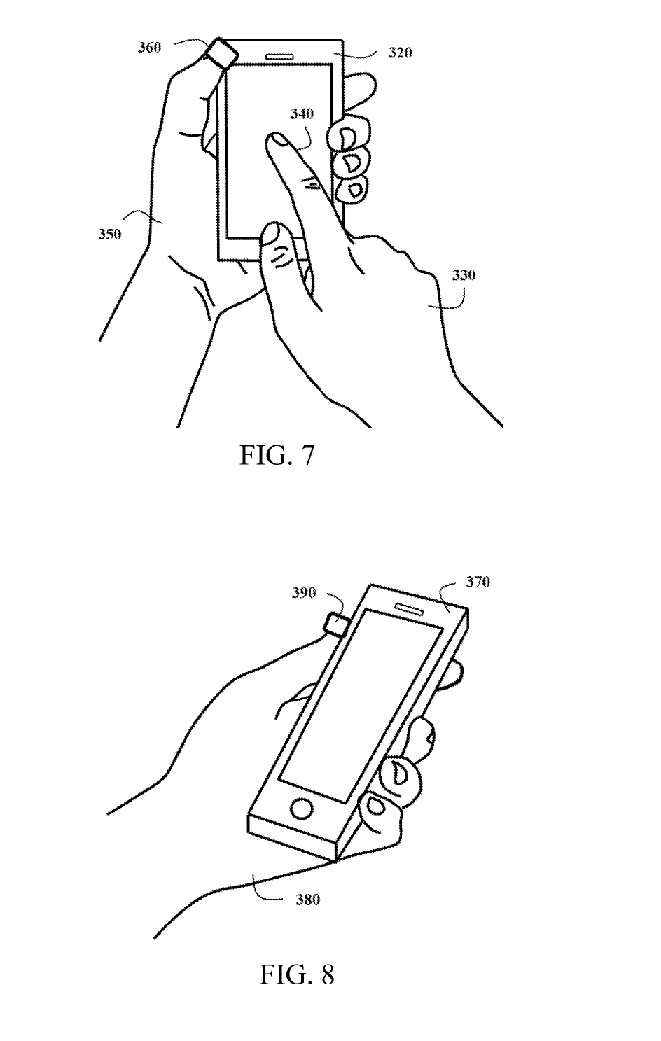

Generally, the device of the present invention can be simultaneously utilized with the traditional methods of the computer input. For example, FIG. 6 illustrates interacting with a 3D application on a computer display 270 with a left hand 280 that touches the computer touchscreen with a finger 290. At the same time, a right hand 300 utilizes the device 310 of the present invention to interact with the 3D application. The same concept can be used with mobile phones. For example, FIG. 7 illustrates interacting with a 3D application on a mobile phone screen 320 with a right hand 330 that touches the mobile phone screen with a finger 340. At the same time, a left hand 350 utilizes the device 360 of the present invention to interact with the 3D application presented on the mobile phone screen.

Overall, the device of the present invention can be utilized in many more applications than selecting or moving objects in 2D/3D on the computer display. For instance, assigning a unique input or a shortcut to each unique tilting of the device opens the door for various innovative utilizations that increase the user's productivity. For example, FIG. 8 illustrates holding a mobile phone 370 with a hand 380 while using the device 390 of the present invention with the same hand to provide an input to the mobile phone representing shortcuts. The shortcut may lead to opening the user's personal email or accessing to social network account; or dialing a phone number of a friend, or adjusting the camera of the mobile phone, and the like. All such activities are achieved by tilting the device in different directions without touching the mobile phone touchscreen at all.

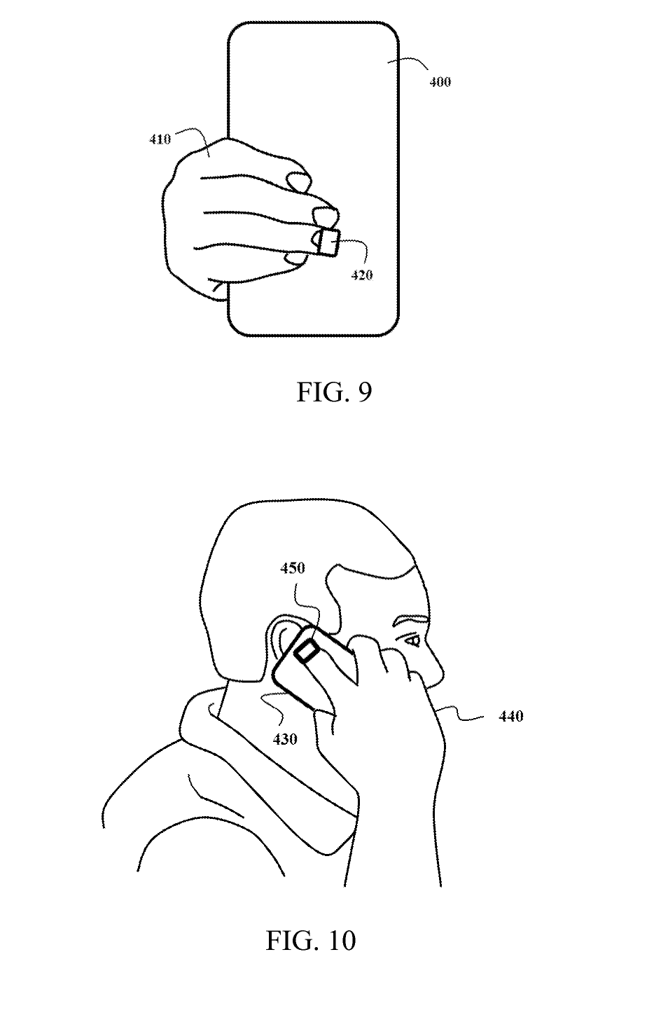

FIG. 9 illustrates a user holding a mobile phone 400 with a hand 410 while using the device 420 of the present invention with the same hand. As shown in the figure, the device touches the back side of a mobile phone to be operated which is a natural position for the hand while holding the mobile phone. In FIG. 10, a user is talking on the mobile phone 430 while holding the mobile phone with a hand 440. The device 450 of the present invention is used with the index finger in a natural position for the hand while the user is holding and talking on the phone. In this case, the device can provide a variety of useful shortcuts to the mobile phone while the user is talking on the phone, without the need to move the mobile phone away from the ear to view the mobile phone screen.

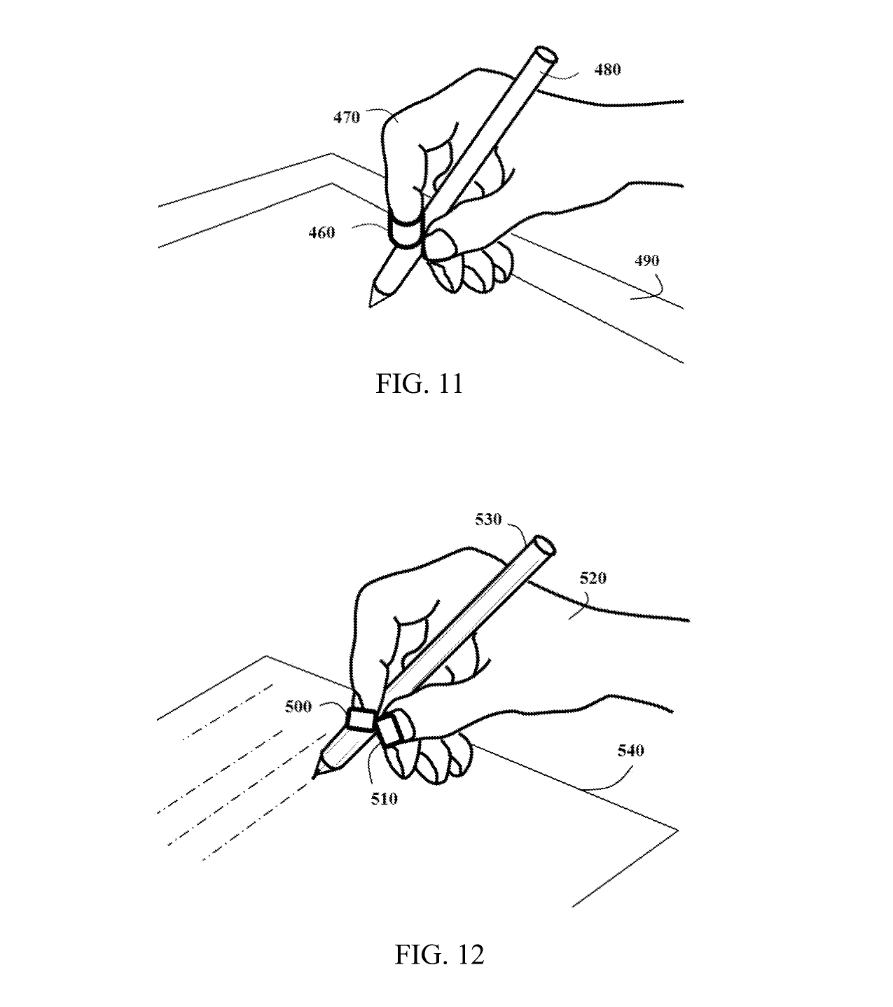

In FIG. 11 illustrates using the device 460 of the present invention by a hand finger 470 while holding a stylus 480 with the same hand to interact with an application on a tablet screen 490. FIG. 12 illustrates using two devices 500 and 510 of the present invention with two fingers of a hand 520 while writing with a pencil 530 on a piece of paper 540. In all such cases, the device of the present invention provides an input to the computer system while the user is simultaneously performing another task such as drawing with a stylus or writing with a pencil. Accordingly, the user's productivity is dramatically increased by using multiple input devices at the same time.

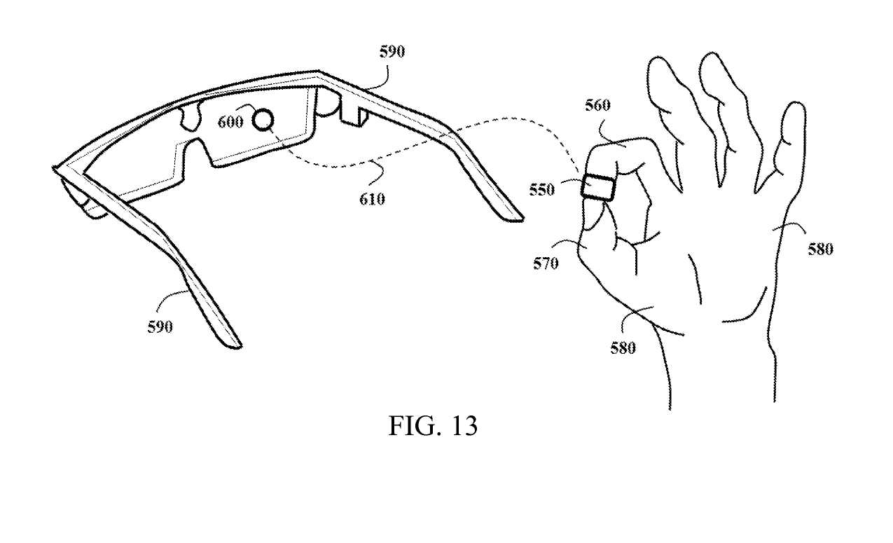

FIG. 13 illustrates using the device 550 of the present invention with the index finger 560 while touching the device with the thumb finger 570 of the same hand 580. In this case, there is no need to use a surface to tilt the device, as the index and thumb fingers together are enough for tilting the device. In this example, the device is wirelessly connected to a head mounted computer display (HMD) in the form of eye glasses 590 to manipulate an object 600 to move in 2D/3D on the glasses or the display. The dotted line 610 in the figure is just a representation for the wireless connection between the device and the HMD. Such utilization of the device is perfect for a user to interact with the HMDs while s/he is walking in the street, driving the car, or lying supine.

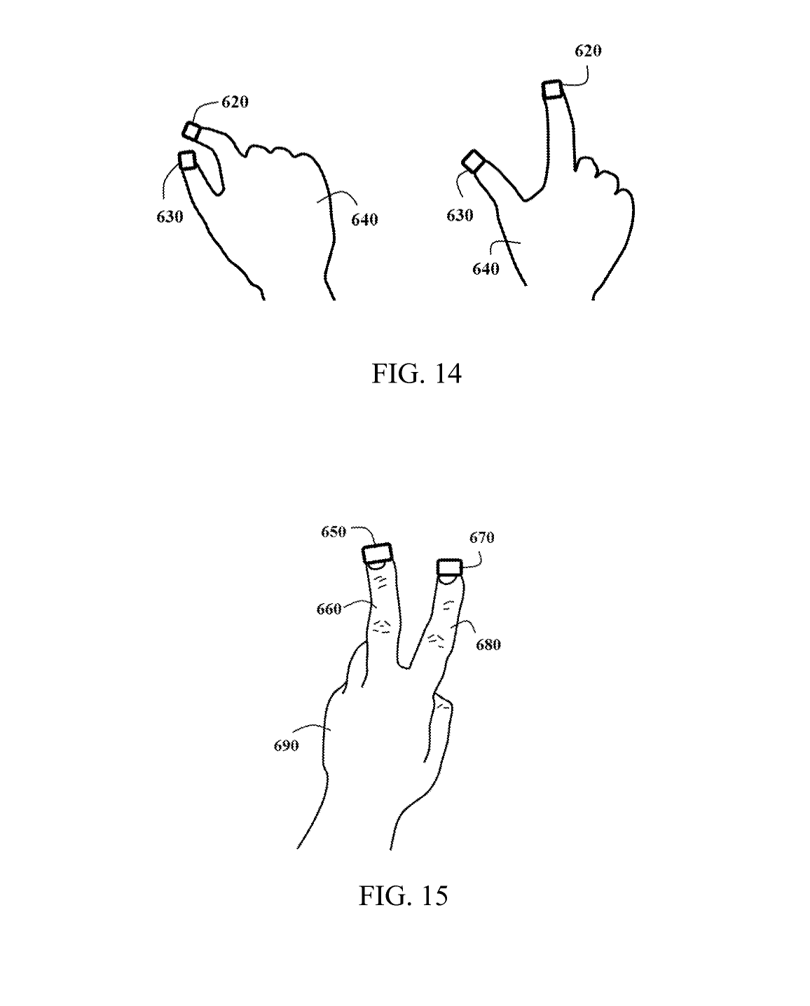

FIG. 14 illustrates simultaneously using a first device 620 and a second device 630 of the present invention with the same hand to provide an immediate input to the computer system. In this case, each unique combination of tilting for the first and second devices will be interpreted as a unique input to the computer system. Accordingly, once the two devices touch the surface with a specific tilting, the computer system will interpret that as a certain input. In this case, there is no need to move the two devices on the surface, as their simultaneous touch is enough for providing the input. Of course, the simultaneous movement of the two devices on the surface can provide more unique inputs to the computer system than just touching the device. However, the advantage of providing the input with touch is easy and speed of executable actions on the part of the user.

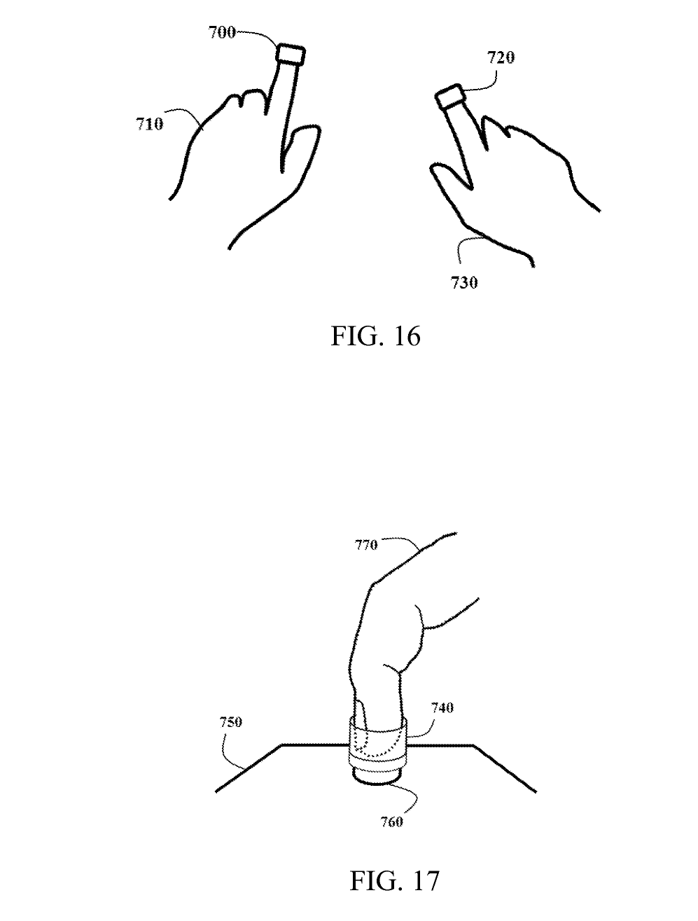

FIG. 15 illustrates using a first device 650 with the middle finger 660, and a second device 670 with the index finger 680 of the same hand 690 contrast to the use of the index and thumb fingers illustrated in the previous example. FIG. 16 illustrates using a first device 700 with the left hand 710 and a second device 720 with the right hand 730 to provide a simultaneous input with the two devices to the computer system. In this case, the simultaneous movement of the two devices relative to each other on a surface can create a huge number of paths that can be interpreted into a large number of different inputs to the computer system.

FIG. 17 illustrates attaching the device 740 of the present invention to the surface 750 of a computer, touchscreen, or computer mouse using a gluing tap 760. In this case, the user's finger 770 is inserted inside the first part of the device when operating the device. Once the user finishes his/her interaction with the computer application, s/he may simply remove his/her finger out of the first part of the device. Using a gluing tap that can be easily reused enables the user to move the device with the gluing tap from one surface to another.

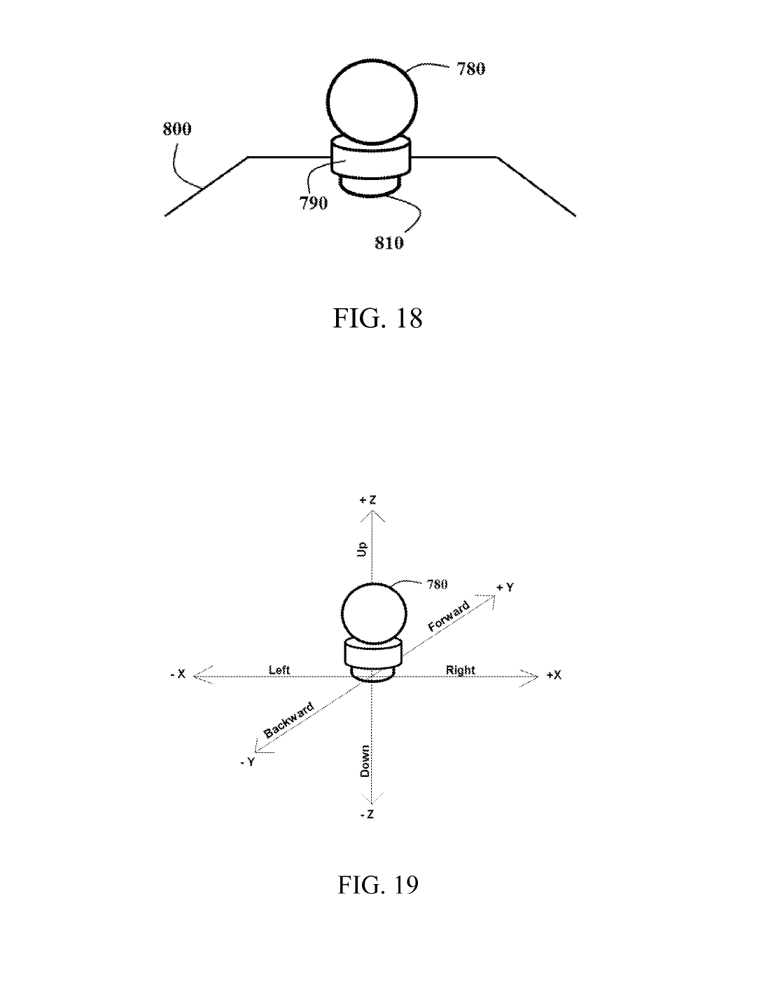

FIG. 18 illustrates replacing the first part of the device with a ball 780 such that the second part 790 of the device remains attached to a surface 800 by the gluing tap 810. In this case, the user grips the ball with his/her hand to tilt the device while it is attached to the surface. Such configuration of the device enables the user to provide six degree of freedom to the computer system to move/rotate objects in 3D on the computer display.

For example, to provide the computer system with an input representing a movement along the positive or negative x-axis, the ball is successively pushed from left to right, or from right to left. To provide the computer system with an input representing a movement along the positive or negative y-axis, the ball is successively pushed forward or backward. To provide the computer system with an input representing a movement along the positive or negative z-axis, the ball is successively pushed down or pulled up.

To provide the computer system with an input representing a clockwise rotation or a counter-clockwise rotation about the x-axis, the ball is successively tilted forward or backward. To provide the computer system with an input representing a clockwise rotation or a counter-clockwise rotation about the y-axis, the ball is successively tilted to the right, or to the left. To provide the computer system with an input representing a clockwise rotation or a counter-clockwise rotation about the z-axis, the ball is successively twisted clockwise or counter-clockwise parallel to the surface plane. FIG. 19 illustrates the x, y, and z-axis relative to the ball 780 of the device to clarify the directions of pushing or tilting the ball while providing six degrees of freedom to the computer system.

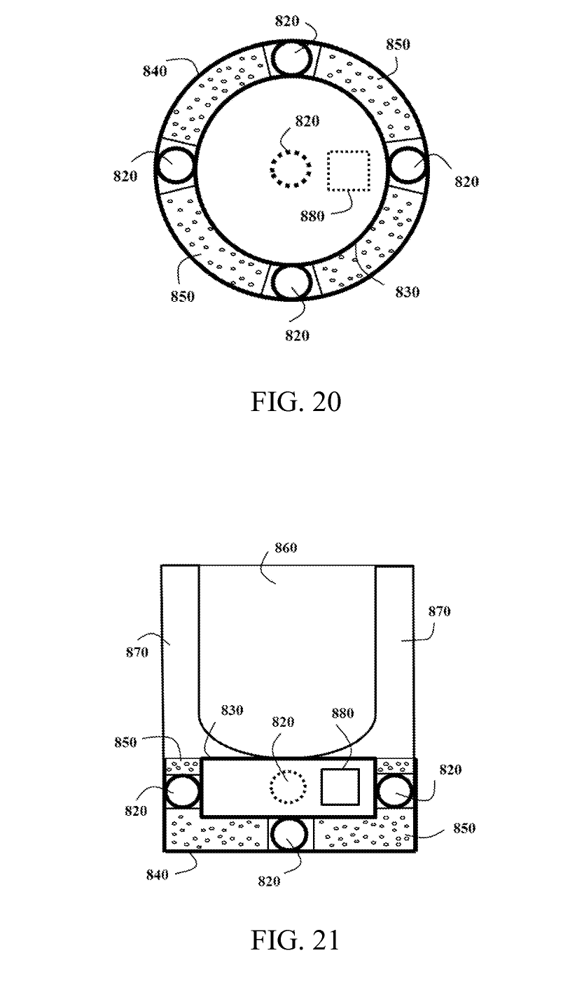

FIG. 20 illustrates a horizontal section, and FIG. 21 illustrates a vertical section for the device of the present invention. As shown in the two figures, five force sensors 820 are placed along the positive x-axis, the negative x-axis, the positive y-axis, the negative y-axis, and the negative z-axis relative to the center of an interior cylinder 830. An exterior cylinder 840 covers the five sensors whereas a flexible material such a rubber 850 is positioned between the interior and exterior cylinders to enable the exterior cylinder to move when a force is exerted on its surface. Once the force is released the exterior cylinder returns to its default position. At the same time, the interior cylinder does not move with the exterior cylinder movement, which makes the force exerted on the exterior cylinder is translated to the sensors. The void 860, which appears in the vertical section, is where a user's finger is inserted to attach and move the device with the finger movement. A flexible material 870 surrounds the void to secure the attachment between the finger and the device. The processor 880 is located inside the interior cylinder to receive and analyze the signals generated by the sensors.

According to the invention described in the U.S. patent application Ser. No. 12/587,339, when a force is exerted from any 3D direction on the exterior cylinder, each one of the five sensors receives a different value of this force. Providing these values to a microprocessor enables determining the position of the force, the 3D direction of the force, and the value of the force. In the case of moving the device on a surface, the friction between the surface and the device is the source of the exerted force. When tilting the device on a surface without movement, the force exerted from the finger on the top side of the interior cylinder is the source of the exerted force.

The microprocessor can be wirelessly connected to a computer system of a computer, tablet, mobile phone, HMD, or the like. The microprocessor receives the signals of the sensors that represent the value of the force exerted on each sensor, then analyzes the signals to provide a data to a computer system representing the position of the touch, the 3D direction of the force and the value of the force at the point of touch. The position of the touch and the 3D direction of the force enable the computer system to determine the start point and the 3D direction of the ray that represents a 3D direction of movement on the computer display. The value of the force may represent the speed of the movement. The time of movement along the 3D direction of the ray depends on the length of the time period that the microprocessor keeps sending the same data to the computer system. In other words, the time period of the movement on the computer screen is the same time period of tilting the device on a surface.

The sensors of the present invention can be in other forms than the force sensors. For example, the sensors can be tracking cameras that capture the pictures of the object when touching the surface. Analyzing the pictures determines the point of touch, the three-dimensional direction of the force, and the value of the force exerted from the object on a surface. The point of touch is the point where the object meets the surface in the pictures. The three-dimensional direction is the direction of the object in the pictures at the moment of touch.

The value of the force can be detected from the impact of the force on the surface that also appear in the pictures. For instance, if the surface is made of a flexible material, the bending of the surface that appears in the pictures at the moment of touch represents the value of the force. If the surface is covered of a pressure sheet that detects the pressure exerted on the sheet, as known in the art, the value of the pressure represents the value of the force. In fact, this is just two examples of many methods or tools that can utilized in detecting the point of touch, the three-dimensional direction of the force, and the value of the force exerted from an object on a surface.

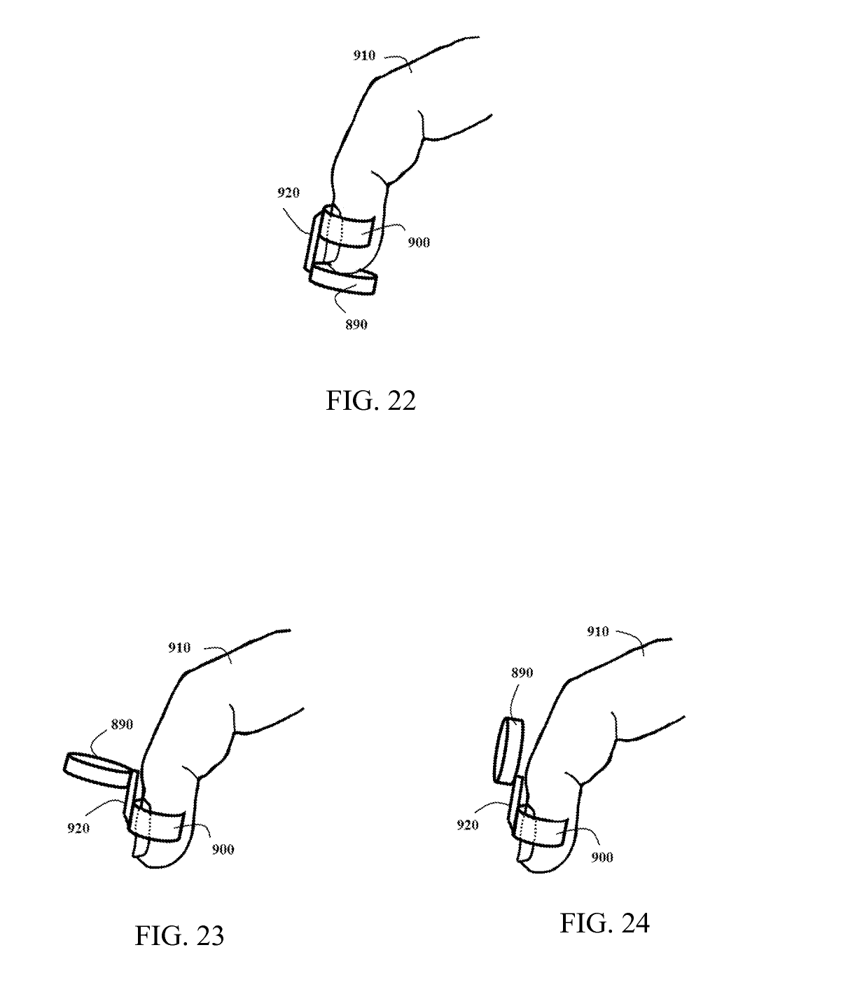

Generally, the device of the present invention can take various forms or designs to suit the user's needs or preference. For example, FIG. 22 illustrates another design for the device of the present invention comprised of three parts. The first part 890 contains the electronic component of the device such as the sensors and the microprocessor. The second part 900 is a semi hollow cylinder to be attached to the user's finger 910. The third part 920 is the connector between the first part and the second part. FIGS. 23 and 24 illustrate rotating the first part to be in a vertical position or in a horizontal position relative the user's finger. The main advantage of this form or design of the device is giving a choice to the user to stop using the device while still keeping it attached to his/her finger.

Conclusively, while a number of exemplary embodiments have been presented in the description of the present invention, it should be understood that a vast number of variations exist, and these exemplary embodiments are merely representative examples, and are not intended to limit the scope, applicability or configuration of the disclosure in any way. Various of the above-disclosed and other features and functions, or alternative thereof, may be desirably combined into many other different systems or applications. Various presently unforeseen or unanticipated alternatives, modifications variations, or improvements therein or thereon may be subsequently made by those skilled in the art which are also intended to be encompassed by the claims, below. Therefore, the foregoing description provides those of ordinary skill in the art with a convenient guide for implementation of the disclosure, and contemplates that various changes in the functions and arrangements of the described embodiments may be made without departing from the spirit and scope of the disclosure defined by the claims thereto.

1. A computer input device to provide the computer system with three simultaneous inputs representing a start point of a movement, a three-dimensional direction of the movement, and a speed of the movement wherein the computer input device is comprised of;
a chassis to be located between two objects exerting a force on the chassis wherein the force touches the chassis at a position with a three-dimensional angle and a value;
a sensing unit to detect and generate signals representing the position, the three-dimensional angle, and the value of the force;
a microprocessor to receive the signals from the sensing unit and provide the three simultaneous inputs to the computer system.

2. The computer input device of claim 1 wherein the position of the force represents the start point the movement, the three-dimensional angle of the force represents the three-dimensional direction of the movement, and the value of the force represents the speed of the movement.

3. The computer input device of claim 1 wherein the start point represents a spot on a computer display and the three-dimensional direction represents a path of a ray starting at the spot to select an object in three-dimensions on the computer display.

4. The computer input device of claim 1 wherein the start point represents a spot on a computer display and the three-dimensional direction represents a path of a ray starting at the spot to select an object in two-dimensions on the computer display.

5. The computer input device of claim 1 wherein the three-dimensional direction is represented by a first angle located between the xy-plane and a line representing the force, and a second angle located between the projection of the line on the xy-plane and the x-axis.

6. The computer input device of claim 1 wherein the two objects are a fingertip and a touchscreen that detects the location of touch between the chassis and the touchscreen.

7. The computer input device of claim 1 wherein the two objects are a fingertip and a surface.

8. The computer input device of claim 1 wherein the two objects are a fingertip and the side surface or the back surface of a hand-held device.

9. The computer input device of claim 1 wherein the two objects are a stylus or pen and a surface.

10. The computer input device of claim 1 wherein the chassis is attached to a surface and the force is generated by tilting or pushing the chassis in a certain direction.

11. The computer input device of claim 1 wherein the movement and tilting of the chassis provide the computer system with an immediate input representing six degrees-of-freedom.

12. The computer input device of claim 1 wherein the sensing unit is comprised of a plurality of fore sensors to detect the vertical force or the horizontal force exerted on each sensor of the plurality of force sensors.

13. The computer input device of claim 1 wherein the sensing unit is a plurality of cameras positioned to capture the pictures of the two objects at the moment of touch wherein analyzing the pictures determines the position, the three-dimensional angle, and the value of the force.

14. The computer input device of claim 1, further two or more of the computer input device are simultaneously operated by two or more fingers of a single hand or two hands.

15. The computer input device of claim 13 wherein the value of the force is determined by the bending of the surfaces of the two objects that appears in the pictures.

16. The computer input device of claim 14 wherein each unique input of the two or more of the computer input device represents a unique shortcut to the computer system.

17. The computer input device of claim 15, further a pressure sheet is positioned between the two objects wherein the pressure sheet detects the value of the force.

18. A method for providing an input to the computer system representing a location of a point, a three-dimensional direction and a value wherein the method comprising;
exerting a force from a first object on a second object at a location of a point with a three-dimensional direction, and a value;
detecting the location of the point, the three-dimensional direction and the value; and
providing the location of the point, the three-dimensional direction and the value to the computer system.

19. A method for providing an input to the computer system representing a shortcut wherein the method comprising;
simultaneously exerting two or more forces in three-dimensions from two or more objects on a surface;
detecting the three-dimensional direction and the value of each force of the two or more forces; and
associating each unique combination of three-dimensional directions and values of the two or more forces with a unique input representing a shortcut.

20. The method of claim 19 wherein the shortcut represents a command for starting a software application or a function, or opening an Internet page or a form on the computer display.
